(19) United States
(12) Patent Application Publication
(10) Pub. No.: US 2024/0125970 A1
(43) Pub. Date: Apr. 18, 2024

(54) METHOD AND MACHINE-READABLE MEDIUM FOR BUILDING 2D DEPOSITIONAL MODELS

(71) Applicant: SAUDI ARABIAN OIL COMPANY, Dhahran (SA)

(72) Inventor: Fawwaz M. ALKHALDI, Dhahran (SA)

(73) Assignee: SAUDI ARABIAN OIL COMPANY, Dhahran (SA)

(21) Appl. No.: 18/046,398

(22) Filed: Oct. 13, 2022

(51) Int. Cl. G01V 99/00; E21B 49/02

(52) U.S. Cl. CPC G01V 99/005; E21B 49/02; E21B 2200/20

(57) ABSTRACT

A method may include receiving a core description comprising a plurality of lithofacies and at least one sequence boundary, generating a depositional ordering model of the plurality of lithofacies from the core description, and using the depositional ordering model to construct a 2D depositional model of a horizontal arrangement of the plurality of lithofacies.

### FIELD OF THE DISCLOSURE

The present disclosure relates generally to building depositional environment models and, more particularly, to reconstructing depositional environment models through the analysis of the vertical stacking of lithofacies.

### BACKGROUND OF THE DISCLOSURE

During the formation of hydrocarbon reservoirs, the quality and size is determined during or immediately after the deposition of the sedimentary rock. As such, through a deeper understanding of the deposition process, and specifically the environment at the time of deposition, predictions may be determined regarding the presence and quality of hydrocarbons within an area. One such method for the understanding of deposition is the reconstruction of the depositional environment via a vertical rock description profile. These vertical rock description profiles have been traditionally sourced from geological outcrops which display the stacking of lithofacies above the surface. However, with many rock intervals lacking outcrops, the primary source of these vertical profiles is the acquisition of subsurface core samples which display similar geological information.

Using Walther's law of facies, the assumption may be made that lithofacies which were deposited adjacent to one another may become vertically superimposed over time. This assumption allows for the reconstruction of the original depositional environment which has followed depositional cycles resulting from base-level rise and fall, or a cycle of transgression and regression. As such, the complex succession of lithofacies may be a result of high-frequency orders of sea-level changes which have previously been divided into specific cycles of transgression and regression based upon individual interpretations of the depositional environments and flooding surfaces. Previously, the lateral relationships for these lithofacies have been reconstructed using data-driven or model-driven techniques. However, no direct method or technique has been developed for the construction of a two-dimensional depositional environmental model.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method may include receiving a core description comprising a plurality of lithofacies and at least one sequence boundary, generating a depositional ordering model of the plurality of lithofacies from the core description, and using the depositional ordering model to construct a 2D depositional model of a horizontal arrangement of the plurality of lithofacies.

In another embodiment, a non-transitory computer-readable medium may store machine-readable instructions, which, when executed by a processor of an electronic device, cause the electronic device to receive a core description comprising a plurality of lithofacies and at least one sequence boundary, generate a depositional ordering model of the plurality of lithofacies from the core description, and construct a 2D depositional model of a horizontal arrangement of the plurality of lithofacies.

In a further embodiment, a system may include a core sample analysis module operable to generate a core description, a depositional ordering model module operable to generate a depositional ordering model from the core description, a 2D depositional model module operable to generate a 2D depositional model from the depositional ordering model, a hydrocarbon assessment module operable to determine, based on the depositional ordering model and the 2D depositional model, the presence and/or quality of hydrocarbons within a rock or formation of interest, and a hydrocarbon extraction module operable to generate control information for the operation of hydrocarbon extraction equipment.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a flowchart of an example method for analyzing a vertical stacking of lithofacies.

FIG. 2 is an example stacking of lithofacies with defined sequence boundaries.

FIG. 3 is an example chart for the visualization of the lithofacies classification and realization process.

FIG. 4 is an example visualization of a symmetrical lithofacies group.

FIG. 5 is an example circle of probabilities plot in accordance with one or more embodiments of the present disclosure.

FIG. 6 is an example model set resulting from the method for analyzing a vertical stacking of lithofacies.

FIG. 7 is a flowchart of an example method for the construction of a 2D depositional model from a core sample.

FIG. 8 is an example 2D depositional model constructed by the methods described herein.

FIG. 9 is a block diagram of an example system for the construction of a 2D depositional model

FIG. 10 is an example flowchart for the creation of a 2D depositional model from a core sample

FIG. 11 is an example computer system that can be employed to execute one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to building depositional environment models and, more particularly, to reconstructing depositional environment models through the analysis of the vertical stacking of lithofacies. The methods for reconstruction may be applied to carbonate deposits, and may analyze the complex vertical succession of lithofacies which may be overlooked using conventional model construction techniques. The constructed model may also account for lateral associations and the paleo relief of the modeled deposits, as well as their location on the geological platform with reference to sea level, fair-weather wave base, and storm wave base. Further, the methods outlined in this disclosure may aid in the identification of misplaced sequence boundaries, the construction of models involving thick rock intervals containing many lithofacies, the simultaneous identification of depositional models for the same rock intervals, and the prediction of relationships between lithofacies not observed but that were previously associated with a similar sequence.

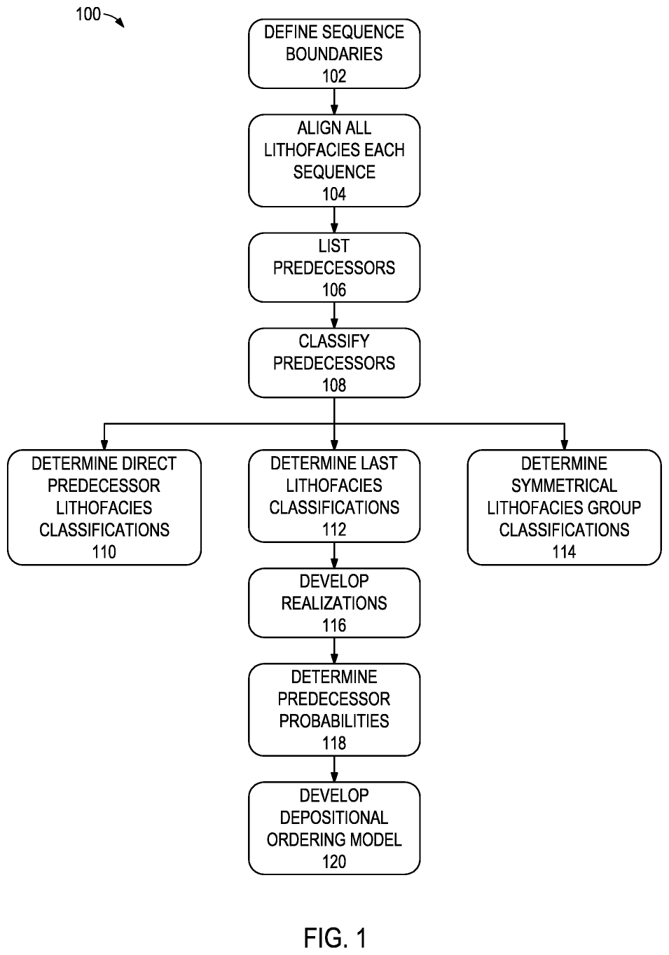

FIG. 1 is a flowchart of an example method 100 for analyzing a vertical stacking of a plurality of lithofacies. The method 100 may be computer-implemented and may allow a received core description, or vertical stacking of lithofacies, to be translated into a historical depositional ordering model which orders the lithofacies in their original depositional setting. The method 100 may begin at 102, in which at least one sequence boundary may be defined within a vertical stacking of lithofacies. These sequence boundaries may be established based upon published criteria and physical observations of the sequence boundary or depositional interrupted surfaces, which may be irregular or sharp contacts. The sequence boundaries may be unconformable surfaces which separate related strata of lithofacies from neighboring strata, and may be essential in the deconstruction of a vertical stacking of lithofacies such that the correct interrelations are maintained and separated by these depositional hiatuses.

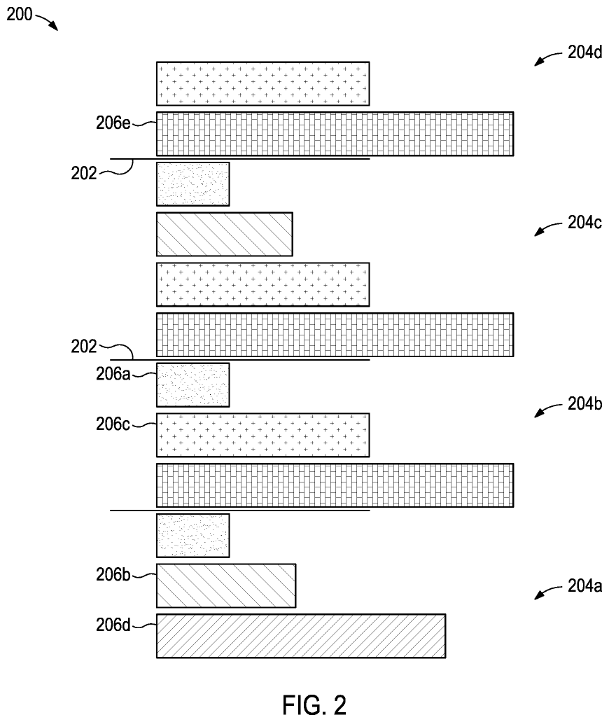

Referring briefly to FIG. 2, illustrated is an example stacking of lithofacies 200 with defined sequence boundaries 202. The sequence boundaries 202 may be seen to divide the stacking of lithofacies 200 into a series of sequences 204a-d, with the first sequence 204a on the bottom of the stack. The sequences 204a-d may comprise different types of lithofacies 206a-e in different orders. For example, in the illustrated embodiment the first sequence 204a is formed from a fourth type of lithofacies 206d, a second type of lithofacies 206b, and a first type of lithofacies 206a. The types of lithofacies 206a-e may be classified based upon their depositional similarities, and are represented in FIG. 2 such that the length of the bar each type of lithofacies 206a-e corresponds to the type of lithofacies 206a-e. As such, the first lithofacies 206a may be represented as the shortest bar while the fifth lithofacies 206e may be represented as the longest bar. Those skilled in the art will readily appreciate that the types of lithofacies 206a-e may be represented in many other manners, and further numbers of types of lithofacies 206a-e may be included, without departing from the scope of this disclosure.

Returning now to FIG. 1, after the definition of the sequence boundaries within a vertical stacking of lithofacies at 102, the method may continue at 104 with the alignment of the lithofacies within each sequence. Using the first sequence 204a as an example, a left-aligned sequence would be the first type of lithofacies 206a, the third type of lithofacies 206c, and the fifth type of lithofacies 206e, or f₁-f₃-f₅ in simpler terms. This alignment may be applied to each sequence 204a-d from FIG. 2, such that a series of horizontal sequences are determined. Following the alignment and horizontal sequencing of the lithofacies at 104, the method may continue at 106 with the determination of predecessors within each sequence. Utilizing the aligned sequences 204a-d, each type of lithofacies 206a-e may be analyzed to determine the type of lithofacies 206a-e which comes before it in each sequence that it is present. As an example, using the first type of lithofacies 206a would yield nothing for the fourth sequence 204d, the second type of lithofacies 206b for the third sequence 204c, the third type of lithofacies 206c for the second sequence 204b, and the second type of lithofacies 206b for the first sequence 204a. In this way, the predecessors for the first type of lithofacies 206a may be represented as f₂-f₃-f₂. This process may repeat within 106 until each type of lithofacies 206a-e has a group of predecessors extracted from the sequences 204a-d.

With the predecessor information extracted for each type of lithofacies 206a-e at 106, the method may continue at 108 with the classification of each predecessor for each type of lithofacies 206a-e. Using the first type of lithofacies 206a again as an example, it may be seen that f₂, or the second type of lithofacies 206b, is the most dominant predecessor, as it has the highest frequency of occurrence as a predecessor to the first type of lithofacies 206a. Similarly, it may be seen that f₃, or the third type of lithofacies 206c, is the least common predecessor for the first type of lithofacies 206a. This process may again be repeated for each type of lithofacies 206a-e to yield the most dominant predecessor, the least dominant predecessor, or one-time occurrences as predecessors.

After the determination of the predecessor classifications at 108, the relationship between the types of lithofacies 206a-e may be further classified at 110, 112, and 114. At 110, any direct predecessor lithofacies may be determined, such that a direct predecessor lithofacies is defined as a lithofacies which has only one dominant predecessor from 108. As such, the second type of lithofacies 206b may be considered a direct predecessor lithofacies to the first type of lithofacies 206a. At 112, any last lithofacies may be classified, such that a last lithofacies is any type of lithofacies 206a-e which is present as a predecessor for other types of lithofacies 206a-e, but which lacks any predecessor itself. As an example, the fifth type of lithofacies 206e may be present as a predecessor for the fourth type of lithofacies 206d, but lacks any predecessor itself, and as such may be classified as a last lithofacies.

At 114, any symmetrical lithofacies groups may be determined, such that a symmetrical lithofacies group may be defined as any type of lithofacies fₓ which has a predecessor lithofacies f_{y} in at least one sequence 204a-d while f_{y} has a predecessor lithofacies fₓ in at least one separate sequence 204a-d. In this case, the formation of a symmetrical lithofacies group may be a result of lateral shifting or changing in hydrodynamic energy during the depositional process. As such, symmetrical lithofacies groups may be subject to further analysis based on hydrodynamic energy and other sedimentological parameters such as sedimentary structures. In this way, a determination may be made of the true structure of these symmetrical lithofacies groups, such as f_{y}-fₓ-f_{y} within the group itself.

At 116, the classifications determined at 110, 112, and 114 may be utilized to develop realizations of the true sequencing of the lithofacies during deposition. These realizations may be based upon the predecessor information and classifications determined at 108, 110, 112, and 114, as opposed to the original sequencing information. As such, with only three of the five types of lithofacies 206a-e having predecessors, only three realizations may be developed from the example stacking of lithofacies shown in FIG. 2. As an example, the first type of lithofacies 206a has a dominant, direct predecessor in the second type of lithofacies 206b and a less frequent predecessor in the third type of lithofacies 206c. As such, the realization formed at 116 may include f₁, the first type of lithofacies 206a, closely clustered to f₂, the second type of lithofacies 206b, at a proximal end with f₃, the third type of lithofacies, spaced further away towards the distal end. A second realization may include f₂, the second type of lithofacies 206b, at a proximal end and spaced further away from f₃, the third type of lithofacies 206c at a proximal end closely clustered with f₄, the fourth type of lithofacies 206d. The final realization formed at 116 may include f₃, the third type of lithofacies 206c, closely clustered to f₅, the fifth type of lithofacies 206e, at a proximal end. After the realizations are completed at 116, the probabilities of the presence of the facies may be determined and plotted at 118 prior to the full model development.

At 118, a probability table may be developed for the likelihood of the presence of the successor lithofacies, as shown below in Table 1. As seen in Table 1, the information previously utilized in the realizations and classifications of the stacked lithofacies may be used to represent the succession (or precession) of the lithofacies in a probabilistic manner. This information may be used at 118 to additionally create a diagram, such as a circles of probability plot, for the visualization of probabilities and may aid in the determination of depositional ordering models at 120. Regardless of the plotting or the visualization, the depositional ordering models may be fully developed at 120 such that further visualization or analysis may be performed with an objective depositional ordering model of the original depositional lithofacies order obtained from the present, vertical stacking of lithofacies.

TABLE 1
Example table of successor probabilities.

| | Probability of Occurrence After Lithofacies | | | | |
|---|---|---|---|---|---|
| | f₁ | f₂ | f₃ | f₄ | f₅ |
| None | — | — | — | 100% | 100% |
| f₁ | — | — | — | — | — |
| f₂ | 67% | — | — | — | — |
| f₃ | 33% | 50% | — | — | — |
| f₄ | — | 50% | — | — | — |
| f₅ | — | — | 100% | — | — |

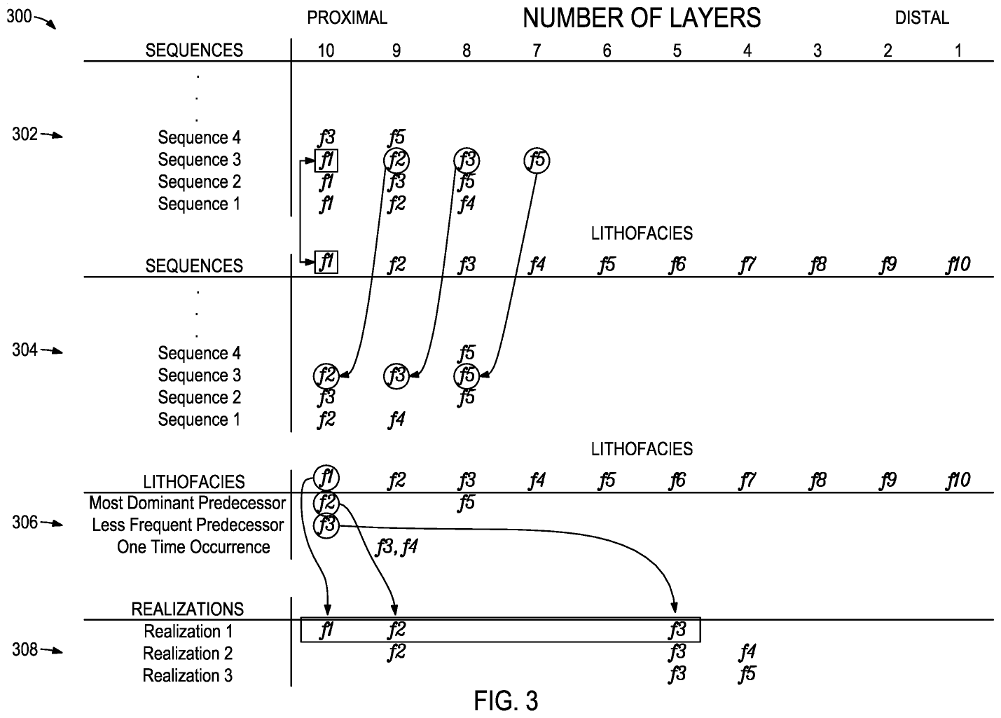

FIG. 3 is an example chart 300 for the visualization of the lithofacies classification and realization process. The chart 300 shows the alignment of lithofacies in row 302, as described previously at 104. In row 302, the ordering of the lithofacies in each sequence may be seen ordered from the proximal to the distal end of each sequence. The row 304 illustrates the listing of predecessors for the example stacking, as described at 106. Using the aligned and ordered lithofacies in row 302, the row 304 displays the predecessor of each lithofacies within each sequence. The information extracted at row 304 may be used in row 306 for the determination of the most dominant, less frequent, and one-time occurrence predecessors for each lithofacies previously provided, as described at 108. The previously described further classification performed at 100, 112, and 114 may additionally be performed using the information shown at row 306. Using the classifications determined in row 306, the lithofacies may be ordered into realizations in row 308, as previously described at 116. These realizations shown in row 308 may be utilized in the construction of ordered and depositional models.

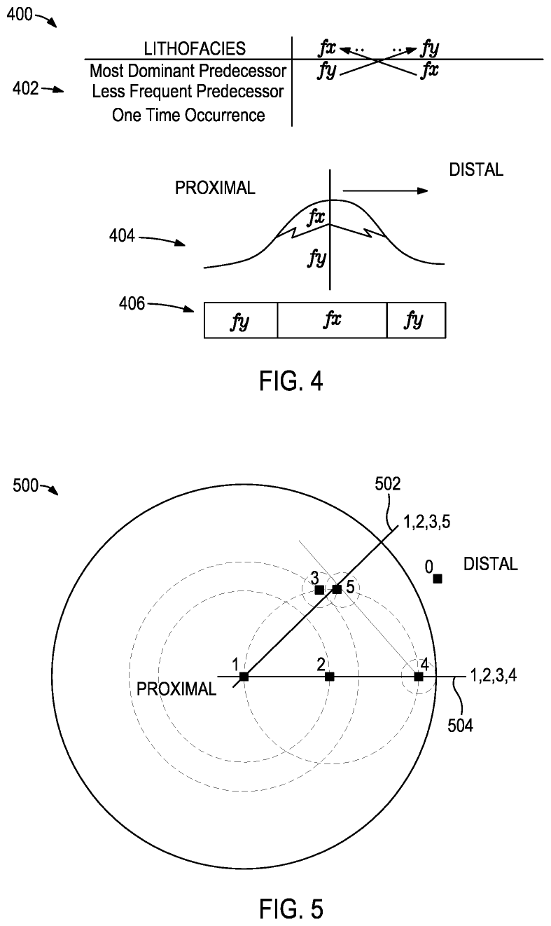

FIG. 4 is an example visualization 400 of a symmetrical lithofacies group. The visualization 400 contains a table 402 which shows an example outcome from row 306 previously discussed, in which two lithofacies maintain each other as the most dominant predecessor in the stacking of lithofacies. In this instance, the determination of a symmetrical lithofacies group may be performed as described at 114 of FIG. 1. The visualization 400 contains a cross-section 404 of the symmetrical lithofacies group previously determined in the table 402, such that the original depositional ordering may be seen. The visualization 400 additionally includes a plan view 406 which displays the symmetrical lithofacies group as it would be represented in an ordered lithofacies model to be used in a 2D depositional ordering model.

FIG. 5 is an example circle of probabilities plot 500 in accordance with one or more embodiments of the present disclosure. The circle of probabilities plot 500, as previously described, may be utilized in the visualization of the realizations and the determination of the objective models to be formed herein. The circle of probabilities plot 500 contains a midpoint which represents the proximal end of the lithofacies stacking, with the radial distance representing the distance from the proximal to the distal end. Each lithofacies may be presented as a sub-circle within the circle of probabilities plot 500, such that each circle is sized corresponding to the probability of the predecessor shown in Table 1. With the formation of each circle within the circle of probabilities plot 500, lines may be drawn from the center of the circle to the edge of the circle, with each sub-circle crossed representing a lithofacies within the possible model. As such, the line 502 represents a first model which includes the lithofacies f₁, f₂, f₃, and f₅, or 206a, 206b, 206c, and 206e. The line 504 represents a second model which includes the lithofacies f₁, f₂, f₃, and f₄, or 206a, 206b, 206c, and 206d. These models may be seen to be the only two possibilities which include the stacked lithofacies as presented, and the circle of probabilities plot 500 may provide a visualization of the determination of these models.

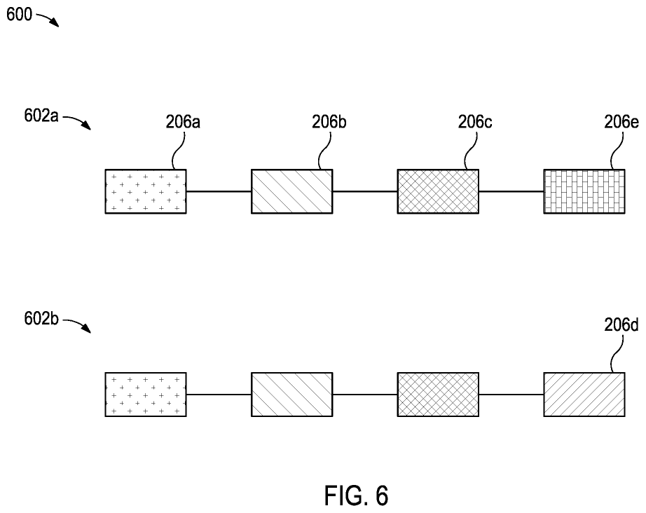

FIG. 6 is an example model set 600 resulting from the method 100 for analyzing a vertical stacking of lithofacies. The example model set 600 may be seen to be the result of the application of the method 100 to the example stacking of lithofacies 200, and was visualized in the circle of probabilities plot 500 in FIG. 5. The example model set 600 comprises two separate models 602a,b based upon the probabilities determined in the method 100, wherein each model 602a,b may represent a possible outcome of the process of deposition or a different lithofacies distribution. Model 602a consists of the first three types of lithofacies 206a-c in order from proximal to distal, with the final component in the horizontal arrangement being the fifth type of lithofacies 206e. In contrast, the model 602b consists of just the first four types of lithofacies 206a-d in order from proximal to distal. These models 602a,b may then be utilized in the full construction of 2D depositional models when applied along with additional geological information.

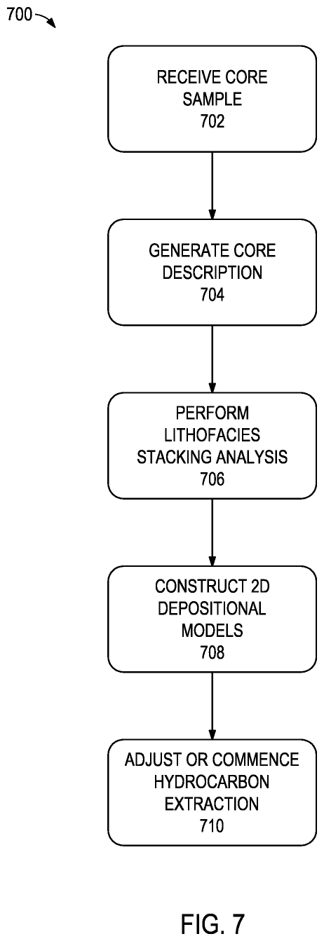

FIG. 7 is a flowchart of an example method 700 for the construction of a 2D depositional model from a core sample. The method 700 may be computer-implemented, and may begin at 702 with the receipt of a core sample. The core sample may be obtained as a preceding part of the method 700, or the core sample may be externally provided for analysis. With the core sample, an analysis may be performed at 704 which visually breaks the sample down into a core description comprising the different lithofacies and the sequence boundaries as previously described. While receiving a core sample as the input, the output core description at 704 may appear similar to the example stacking of lithofacies seen in FIG. 2. Those skilled in the art will readily appreciate that the method 700 may optionally begin at 704 with scans of a core sample provided by a third party, such that the analysis may be performed on a scan or an image without departing from the scope of this disclosure.

The output core description may be used at 706 for the systematic analysis of the lithofacies stacking and depositional ordering. The process of analysis performed at 706 may closely mirror the method 100 of FIG. 1, such that the core description may be divided by sequence boundaries and aligned, the lithofacies may be classified and grouped, and a final model set may be output at 706. Similarly to the previous method step, those skilled in the art will readily appreciate that the method 700 may optionally begin at 706 such that a core description is provided of a core sample or any additional rock without departing from the scope of this disclosure.

The final model set which is output at 706 may then be used at 708 to construct a 2D depositional model. The 2D depositional model may incorporate the final model set with an initial ramp line for the illustration of changes in topography slope, as well as hydrodynamic energy references, in its construction. The hydrodynamic energy references may include, but are not limited to, the fair-weather wave base, the storm wave base, sea level, and any combination thereof. With the transfer of the resulting order of lithofacies from the final model set to the topography, the final development of the model may be guided by measurements of the previously defined hydrodynamic energy references, the rock fabric, the associated grain types, and the sedimentary structures, or any combination thereof. The constructed 2D depositional model which is formed at 708 may then be utilized in the prediction or determination regarding the presence and/or quality of hydrocarbons within an area, and therefore may cause the adjustment or commencement of hydrocarbon extraction activities at 710. The adjustment or commencement of hydrocarbon extraction activities at 710 may include determining well injection and/or extraction rates, drilling of new wellbores for the extraction of hydrocarbons, drilling of sidetrack wellbores, abandoning active wellbores, identifying reservoir connectivity, and any other activities related to the production of hydrocarbons which may be performed more accurately with valid predictions and modelling.

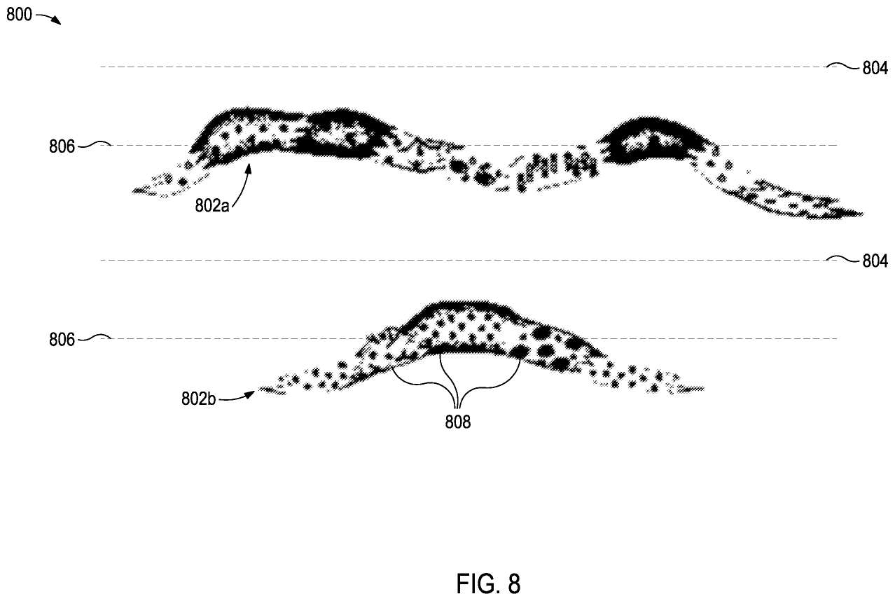

FIG. 8 is an example 2D depositional model 800 constructed by the methods described herein. The example 2D depositional model 800 comprises two separate model sets 802a,b, similar to the output seen in FIG. 6. The 2D depositional model sets 802a,b are each plotted upon two lines 804 and 806, which represent sea level and the fair-weather wave base, respectively. Those skilled in the art will readily appreciate that the 2D depositional model sets 802a,b may additionally be plotted respective to the storm-wave base, or any other sea level indicator, without departing from the scope of this disclosure. As with the model sets of FIG. 6, the model sets 802a,b may be made up of a plurality of types of lithofacies 808 as illustrated in FIG. 8. The method of representing each individual lithofacies of the plurality of types of lithofacies 808 may vary, but is irrelevant to the end result so long as the representation is consistent and differentiable.

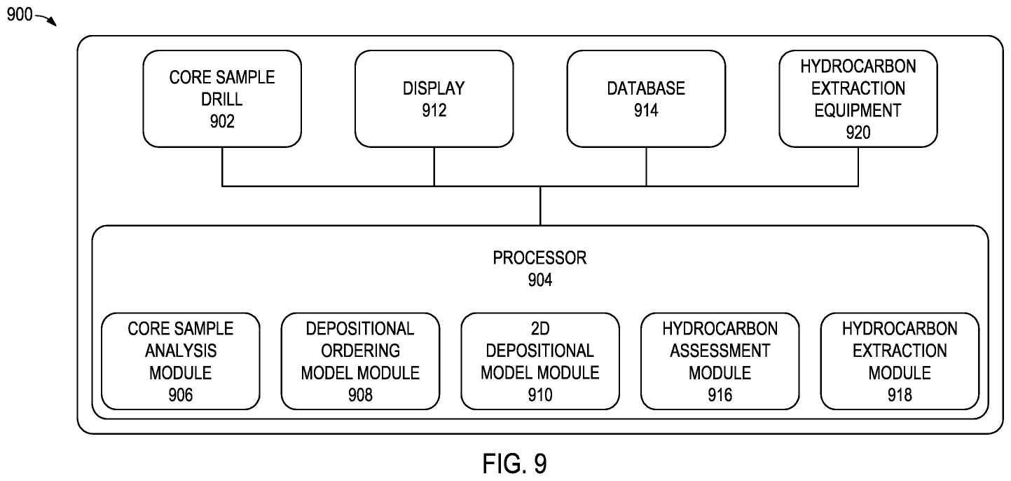

FIG. 9 is a block diagram of an example system 900 for the construction of a 2D depositional model. The system 900 may include a core sample drill 902, such that a core sample may be obtained directly from the rock or formation of interest. The system 900 may further include a processor 904 which comprises a series of modules for the analysis, construction, and utilization of a depositional model. Using the core sample obtained from the core sample drill 902, the processor 904 may include a core sample analysis module 906. The core sample analysis module 906 may allow for the generation of a core description (e.g., the core description generated at 704 of FIG. 4). The core description generated in the core sample analysis module 906 may be further utilized by the depositional ordering model module 908.

The depositional ordering model module 908 may take a core description as an input and generate a depositional ordering model (e.g., the models 602a,b of FIG. 3). The depositional ordering model module 908 may be able to process hundreds of lithofacies within a sample simultaneously, such that complex models may be developed and core samples may be analyzed which were previously time-prohibitive in their execution. The depositional ordering models may be further applied within the 2D depositional model module 910, such that the depositional order model is used as an input to generate a 2D depositional model which further includes an initial ramp line for the illustration of changes in topography slope, as well as hydrodynamic energy references, in its construction. The hydrodynamic energy references may include, but are not limited to, the fair-weather wave base, the storm wave base, sea level, and any combination thereof.

With the construction of models in the depositional ordering model module 908 and the 2D depositional model module 910, the models may be visualized and shown on a display 912, such that an operator of the system 900 may see the multiple models developed as a result of the core sample analysis. These models may be further stored, along with any pertinent properties and information, on a database 914 which may allow future access of the models and assessment of the models' validity.

The processor 904 may further include a hydrocarbon assessment module 916 which utilizes the models previously generated to predict or determine the presence and/or quality of hydrocarbons within the rock or formation of interest. The hydrocarbon assessment module 916 may include the further construction of models, or the integration of the previously generated modules into existing simulations. The prediction or determination of the hydrocarbon presence or quality in the rock or formation of interest may be further used by the processor 904 as an input to a hydrocarbon extraction module 918. The hydrocarbon extraction module 918 may directly control or modify the operation of the hydrocarbon extraction equipment 920, or indirectly provide control information for such modification, such that the processor 904 may utilize the models and predictions to actively optimize the hydrocarbon extraction activities in the rock or formation of interest. The hydrocarbon extraction module 918 may be responsible for determining well injection and/or extraction rates, drilling of new wellbores for the extraction of hydrocarbons, drilling of sidetrack wellbores, abandoning active wellbores, identifying reservoir connectivity, and any other activities related to the production of hydrocarbons which may be performed more accurately with valid predictions and modelling.

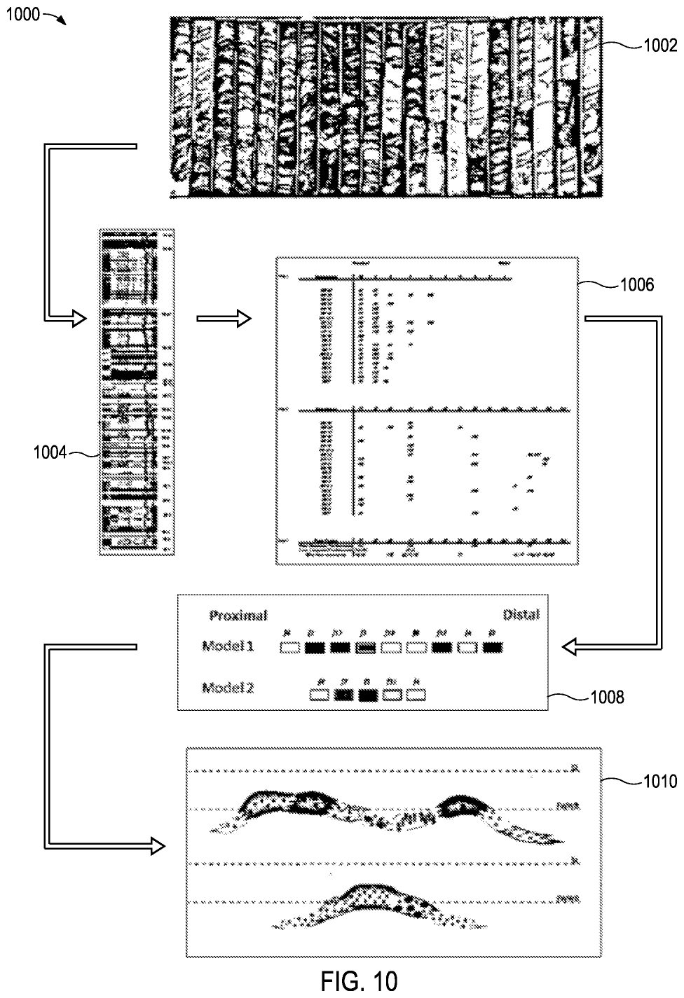

FIG. 10 is an example flowchart 1000 for the creation of a 2D depositional model from a core sample. The flowchart 1000 begins with a core sample visualization 1002 which may be obtained from an extracted core sample or received as an image. The flowchart 1000 may then continue with a core sample description 1004 which includes a stacking of the lithofacies and sequence boundaries from the core sample visualization 1002. With a core sample description 1004, the lithofacies stacking and analysis 1006 is performed, in which the lithofacies may be aligned, ordered, and classified, and in which realizations and probabilities may be extracted. Using the information generated in the lithofacies stacking and analysis 1006, the initial depositional ordering model 1008 may be formed. The initial depositional ordering model 1008 may be developed from a circle of probabilities plot (e.g., the circle of probabilities plot 500 of FIG. 5), or may be directly obtained from the probabilities found in the lithofacies stacking and analysis 1006. The initial depositional ordering model 1008 may be used to construct a 2D depositional model 1010. The 2D depositional model 1010 may incorporate the initial depositional ordering model 1008 with an initial ramp line for the illustration of changes in topography slope, as well as hydrodynamic energy references, in its construction. The hydrodynamic energy references may include, but are not limited to, the fair-weather wave base, the storm wave base, sea level, and any combination thereof. With the transfer of the resulting order of lithofacies from the final model set to the topography, the final development of the model may be guided by measurements of the previously defined hydrodynamic energy references, the rock fabric, the associated grain types, and the sedimentary structures, or any combination thereof. The 2D depositional model 1010 may then be utilized in the adjustment or management of hydrocarbon extraction activities after development within the flowchart 1000, such that more informed decisions may be made relative to the hydrocarbon presence or quality in the rock or formation of interest.

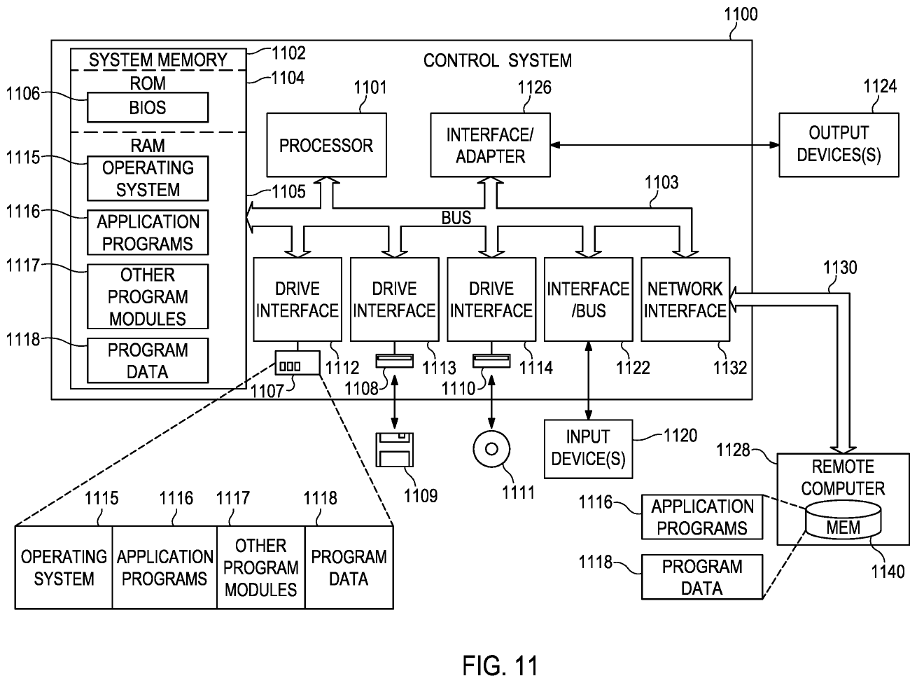

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 11. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 11 illustrates one example of a computer system 1100 that can be employed to execute one or more embodiments of the present disclosure. Computer system 1100 can be implemented on one or more general purpose networked computer systems, embedded computer systems, routers, switches, server devices, client devices, various intermediate devices/nodes or standalone computer systems. Additionally, computer system 1100 can be implemented on various mobile clients such as, for example, a personal digital assistant (PDA), laptop computer, pager, and the like, provided it includes sufficient processing capabilities.

Computer system 1100 includes processing unit 1101, system memory 1102, and system bus 1103 that couples various system components, including the system memory 1102, to processing unit 1101. Dual microprocessors and other multi-processor architectures also can be used as processing unit 1101. System bus 1103 may be any of several types of bus structure including a memory bus or memory controller, a peripheral bus, and a local bus using any of a variety of bus architectures. System memory 1102 includes read only memory (ROM) 1104 and random access memory (RAM) 1105. A basic input/output system (BIOS) 1106 can reside in ROM 1104 containing the basic routines that help to transfer information among elements within computer system 1100.

Computer system 1100 can include a hard disk drive 1107, magnetic disk drive 1108, e.g., to read from or write to removable disk 1109, and an optical disk drive 1110, e.g., for reading CD-ROM disk 1111 or to read from or write to other optical media. Hard disk drive 1107, magnetic disk drive 1108, and optical disk drive 1110 are connected to system bus 1103 by a hard disk drive interface 1112, a magnetic disk drive interface 1113, and an optical drive interface 1114, respectively. The drives and associated computer-readable media provide nonvolatile storage of data, data structures, and computer-executable instructions for computer system 1100. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and ROM 1104, including operating system 1115, one or more application programs 1116, other program modules 1117, and program data 1118. In some examples, the application programs 1116 can include an analyzer or modeler which may perform the method steps outlined in the method 100 of FIG. 1 or the method 700 of FIG. 7, and the program data 1118 can include lithofacies predecessor data, core descriptions, lithofacies order models, and constructed 2D depositional models. The application programs 1116 and program data 1118 can include functions and methods programmed to receive core samples or core descriptions, systematically analyze the stacking of lithofacies, generate ordered models of lithofacies, construct 2D depositional models, and commence or adjust hydrocarbon extraction activities, such as those shown and described herein.

A user may enter commands and information into computer system 1100 through one or more input devices 1120, such as a pointing device (e.g., a mouse, touch screen), keyboard, microphone, joystick, game pad, scanner, and the like. These and other input devices 1120 are often connected to processing unit 1101 through a corresponding port interface 1122 that is coupled to the system bus 1103, but may be connected by other interfaces, such as a parallel port, serial port, or universal serial bus (USB). One or more output devices 1124 (e.g., display, a monitor, printer, projector, or other type of displaying device) is also connected to system bus 1103 via interface 1126, such as a video adapter.

Computer system 1100 may operate in a networked environment using logical connections to one or more remote computers, such as remote computer 1128. Remote computer 1128 may be a workstation, computer system, router, peer device, or other common network node, and typically includes many or all the elements described relative to computer system 1100. The logical connections, schematically indicated at 1130, can include a local area network (LAN) and a wide area network (WAN). When used in a LAN networking environment, computer system 1100 can be connected to the local network through a network interface or adapter 1132. When used in a WAN networking environment, computer system 1100 can include a modem, or can be connected to a communications server on the LAN. The modem, which may be internal or external, can be connected to system bus 1103 via an appropriate port interface. In a networked environment, application programs 1116 or program data 1118 depicted relative to computer system 1100, or portions thereof, may be stored in a remote memory storage device 1140.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such. While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method, comprising:
receiving a core description comprising a plurality of lithofacies and at least one sequence boundary;
generating a depositional ordering model of the plurality of lithofacies from the core description; and
using the depositional ordering model to construct a 2D depositional model of a horizontal arrangement of the plurality of lithofacies.

2. The method of claim 1, further comprising:
determining a presence of hydrocarbons, a quality of hydrocarbons, or any combination thereof, from the 2D depositional model within an area corresponding to the core description; and
adjusting a hydrocarbon extraction activity according to the presence of hydrocarbons, the quality of hydrocarbons, or any combination thereof, determined from the 2D depositional model.

3. The method of claim 1, further comprising:
receiving a core sample; and
generating the core description from the core sample, including the plurality of lithofacies and the at least one sequence boundary.

4. The method of claim 1, wherein the 2D depositional model comprises a plurality of depositional model sets which each represent a possible outcome of a different lithofacies distribution.

5. The method of claim 1, wherein generating the depositional ordering model further comprises:
defining the sequence boundaries received as part of the core description;
aligning the plurality of lithofacies within each sequence defined by the sequence boundaries;
classifying predecessors for each lithofacies of the plurality of lithofacies; and
developing realizations of ordering for the plurality of lithofacies,
wherein the realizations of ordering for the plurality of lithofacies generate the depositional ordering models.

6. The method of claim 5, wherein classifying the predecessors for each lithofacies includes a direct predecessor classification, a last lithofacies classification, a symmetrical lithofacies group classification, or any combination thereof.

7. The method of claim 5, further comprising:
determining a probability for a presence of the predecessors for each lithofacies of the plurality of lithofacies; and
visualizing generation of the depositional ordering models via plotting of the probability for the presence of the predecessors for each lithofacies of the plurality of lithofacies using a circle of probabilities plot.

8. The method of claim 1, wherein construction of the 2D depositional model incorporates hydrodynamic references for sea level, fair-weather wave base, storm wave base, rock fabric, associated grain types, sedimentary structures, or any combination thereof.

9. A non-transitory computer-readable medium storing machine-readable instructions, which, when executed by a processor of an electronic device, cause the electronic device to:
receive a core description comprising a plurality of lithofacies and at least one sequence boundary;
generate a depositional ordering model of the plurality of lithofacies from the core description; and
construct a 2D depositional model of a horizontal arrangement of the plurality of lithofacies.

10. The non-transitory computer-readable medium of claim 9, which further cause the electronic device to:
define the sequence boundaries received as part of the core description;
align the plurality of lithofacies within each sequence defined by the sequence boundaries;
classify predecessors for each lithofacies of the plurality of lithofacies; and
develop realizations of ordering for the plurality of lithofacies,
wherein the realizations of ordering for the plurality of lithofacies generate the depositional ordering models.

11. The non-transitory computer-readable medium of claim 10, which further cause the electronic device to:
determine a probability for a presence of the predecessors for each lithofacies of the plurality of lithofacies; and
visualize generation of the depositional ordering models via plotting of the probability for the presence of the predecessors for each lithofacies of the plurality of lithofacies.

12. The non-transitory computer-readable medium of claim 9, which further cause the electronic device to:
determine a presence of hydrocarbons, a quality of hydrocarbons, or any combination thereof, from the 2D depositional model within an area corresponding to the core description; and
adjust a hydrocarbon extraction activity utilizing the presence of hydrocarbons, the quality of hydrocarbons, or any combination thereof, determined from the 2D depositional model.

13. The non-transitory computer-readable medium of claim 9, which further cause the electronic device to:
receive a core sample; and
generate the core description from the core sample, including the plurality of lithofacies and the at least one sequence boundary.

14. A system comprising:
a core sample analysis module operable to generate a core description;
a depositional ordering model module operable to generate a depositional ordering model from the core description;
a 2D depositional model module operable to generate a 2D depositional model from the depositional ordering model;
a hydrocarbon assessment module operable to determine, based on the depositional ordering model and the 2D depositional model, a presence and/or quality of hydrocarbons within a rock or formation of interest; and
a hydrocarbon extraction module operable to generate control information for an operation of hydrocarbon extraction equipment.

15. The system of claim 14, wherein the 2D depositional model comprises a plurality of depositional model sets which each represent a possible outcome of a depositional process.
